(19) United States
(12) Patent Application Publication
(10) Pub. No.: US 2026/0322780 A1
(43) Pub. Date: Oct. 15, 2026

(54) SUPPORTING OVERLAPPING IPV4 ENDPOINTS IN DIVERSE ACCESS LOCATIONS ACCESSING A CLOUD SERVICE

(71) Applicant: Infoblox Inc., Santa Clara, CA (US)

(72) Inventors: Milan Paliath Ramachandran, Bangalore (IN); Daniel Garcia, Austin, TX (US)

(21) Appl. No.: 19/208,320

(22) Filed: May 14, 2025

Related U.S. Application Data
(60) Provisional application No. 63/788,548, filed on Apr. 14, 2025.

(51) Int. Cl. H04L 61/251; H04L 45/741

(52) U.S. Cl. CPC H04L 61/251; H04L 12/4633; H04L 45/741; H04L 61/2535; H04L 61/4511; H04L 69/167

(57) ABSTRACT

Techniques for supporting overlapping IPv4 endpoints in diverse access locations accessing a cloud service are disclosed. In some embodiments, a system, a process, and/or a computer program product is disclosed that facilitates cloud-based network services, such as DNS and DHCP, for IPv4 endpoints with overlapping address spaces across multiple remote sites. IPv4 traffic from secure tunnels is decrypted at an access termination subsystem and forwarded to a mapping engine, which rewrites source and destination IPv4 addresses into unique IPv6 addresses by embedding site-specific identifiers. A service subsystem processes the IPV6 traffic, and responses are reverse mapped to IPv4 for return transmission. The approach avoids network address translation tables and per-site segmentation overlays, ensuring scalability and compatibility with unmodified IPv4 endpoints. Kubernetes-based routing and load balancing enhance deployment efficiency.

### CROSS REFERENCE TO OTHER APPLICATIONS

This application claims priority to U.S. Provisional Patent Application No. 63/788,548 entitled SUPPORTING OVERLAPPING IPV4 ENDPOINTS IN DIVERSE ACCESS LOCATIONS ACCESSING A CLOUD SERVICE filed Apr. 14, 2025, which is incorporated herein by reference for all purposes.

### BACKGROUND OF THE INVENTION

The rapid expansion of cloud-based network services, such as Domain Name System (DNS), Dynamic Host Configuration Protocol (DHCP), and Internet Protocol (IP) Address Management (IPAM), collectively known as DDI, has enabled organizations to centralize and streamline network operations across diverse geographic locations. These services are often accessed by Internet Protocol version 4 (IPv4) endpoints situated at remote sites, such as branch offices, data centers, or virtual private clouds (VPCs), connected to cloud-hosted platforms via secure tunnels, such as IPsec. A common deployment scenario involves multiple sites utilizing private IPv4 address spaces, such as defined by RFC 1918 (e.g., which is publicly available at https://datatracker.ietf.org/doc/html/rfc1918), to manage local endpoints.

### BRIEF DESCRIPTION OF THE DRAWINGS

Various embodiments of the invention are disclosed in the following detailed description and the accompanying drawings.

FIG. 1 illustrates an example for providing DDI as a service in the cloud in accordance with some embodiments.

FIG. 2 illustrates an example for providing DDI as a service in the cloud to support overlapping IPv4 endpoints in diverse access locations accessing cloud services in accordance with some embodiments.

FIG. 3 illustrates the current format of the IPV6 address.

FIG. 4 illustrates a more flexible format of the IPV6 address in accordance with some embodiments.

FIG. 5 illustrates a format of the IPV6 address to facilitate identification of access locations in accordance with some embodiments.

FIG. 6 illustrates an example addressing table in accordance with some embodiments.

FIG. 7 illustrates example formats depending on the size of an IPV6 prefix in accordance with some embodiments.

FIG. 8 illustrates an example for overlapping IPv4 addresses across several locations in accordance with some embodiments.

FIG. 9 illustrates an example dataflow diagram to support overlapping IPv4 endpoints in diverse access locations accessing cloud services in accordance with some embodiments.

FIG. 10 illustrates a flow diagram of a process to support overlapping IPv4 endpoints in diverse access locations accessing cloud services in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The rapid expansion of cloud-based network services, such as Domain Name System (DNS), Dynamic Host Configuration Protocol (DHCP), and Internet Protocol (IP) Address Management (IPAM), collectively known as DDI, has enabled organizations to centralize and streamline network operations across diverse geographic locations. These services are often accessed by Internet Protocol version 4 (IPv4) endpoints situated at remote sites, such as branch offices, data centers, or virtual private clouds (VPCs), connected to cloud-hosted platforms via secure tunnels, such as IPsec. A common deployment scenario involves multiple sites utilizing private IPv4 address spaces, such as defined by RFC 1918 (e.g., which is publicly available at https://datatracker.ietf.org/doc/html/rfc1918), to manage local endpoints.

However, as organizations scale or integrate with cloud providers (e.g., particularly in scenarios such as hotel chains, mergers, or multi-tenant environments), overlapping IPv4 address spaces across these sites frequently occur, posing significant challenges to seamless service delivery.

Existing approaches to address IPv4 address overlap include careful IP address planning to avoid conflicts, network-based segmentation using existing technologies (e.g., VXLAN), and Network Address Translation (NAT) mechanisms. Each of these existing approaches and their shortcomings will now be discussed below.

IP address planning, while effective in controlled environments, is labor intensive, error prone, and, moreover, becomes technically impractical during integration with external networks or in dynamic deployments where site autonomy is preferred.

Network segmentation, such as encapsulating traffic with VXLAN identifiers, resolves overlaps by isolating site traffic, but this approach generally requires costly per-site service instances, limiting scalability.

NAT-based approaches, which rewrite overlapping IPs to unique addresses, introduce latency, finite table size constraints, and vulnerability to denial-of-service attacks, necessitating complex management strategies, such as rate limiting and load balancing.

As such, these existing approaches often fail to provide a scalable, efficient, and transparent resolution, particularly when customers (e.g., enterprise customers) cannot modify their existing IPv4 configurations, highlighting the need for an improved approach to support overlapping IPv4 endpoints accessing cloud services.

Thus, new and improved techniques are needed to support overlapping IPv4 endpoints accessing cloud services.

### Techniques for Supporting Overlapping IPv4 Endpoints in Diverse Access Locations Accessing a Cloud Service

Accordingly, new and improved techniques to support overlapping IPv4 endpoints in diverse access locations accessing cloud services are disclosed.

Specifically, to support IPv4 endpoints across multiple sites, a scalable solution is disclosed that can integrate with services, including Domain Name System (DNS), Dynamic Host Configuration Protocol (DHCP), and Internet Protocol (IP) Address Management (IPAM), collectively referred to herein as DDI services (and potentially other services in the future).

For example, the disclosed techniques to support overlapping IPv4 endpoints in diverse access locations accessing cloud services address various scenarios where IP addresses may overlap.

In some embodiments, a system, a process, and/or a computer program product for supporting overlapping IPv4 endpoints in diverse access locations accessing cloud services includes receiving Internet Protocol (IP) version 4 (IPv4) traffic at an access termination (e.g., over a secure tunnel); mapping an IPV4 address associated with the IPV4 traffic to an IP version 6 (IPv6) format address and rewrite IPV4 packets associated with the IPV4 traffic into IPV6 packets using the IPV6 format address to generate IPV6 traffic, wherein the IPV6 format address encapsulates an access location associated with a source of the IPV4 traffic; and sending the IPv6 traffic to a cloud service (e.g., an application service).

In an example implementation, the application service includes a DNS service, a DHCP service, or a Network Time Protocol (NTP) service.

In some embodiments, the application service sends a response using the IPV6 traffic, and further comprises: receiving the IPV6 traffic from the application service at the access termination; mapping the IPV6 format address associated with the IPV6 traffic to an IPV4 format address and rewrite the IPV6 packets associated with the IPV6 traffic into the IPV4 packets using the IPV4 format address to generate the IPV4 traffic; and forwarding the IPV4 traffic to the access location associated with the source of the IPV4 traffic.

In an example implementation, the access termination includes a mapping component for mapping IPv4 addresses to IPV6 addresses that include source access locations associated with sources of the IPV4 traffic.

In an example implementation, the access termination receives a plurality of IPV4 sessions from two or more distinct access locations.

In an example implementation, the access termination includes a mapping component for mapping IPV6 addresses to IPv4 addresses and extracting source access locations associated with sources of the IPV4 traffic for routing the IPV4 traffic to the sources of the IPV4 traffic.

In some embodiments, a system, a process, and/or a computer program product for supporting overlapping IPv4 endpoints in diverse access locations accessing cloud services further includes encapsulating and de-encapsulating the IPV4 traffic from a plurality of remote sites.

For example, by applying the disclosed techniques supporting overlapping IPv4 endpoints in diverse access locations accessing cloud services, network address translation (NAT) tables or per-site network segmentation overlays are not required to handle overlapping IPv4 addresses to support overlapping IPv4 endpoints in diverse access locations accessing cloud services.

In some embodiments, a system, a process, and/or a computer program product for supporting overlapping IPv4 endpoints in diverse access locations accessing cloud services further includes an IPV6-capable application-specific load balancer configured to distribute the IPV6 traffic across multiple service pods for scalability and high availability, wherein the load balancer supports at least one of DNS or DHCP services.

In some embodiments, a system, a process, and/or a computer program product for supporting overlapping IPv4 endpoints in diverse access locations accessing cloud services further includes a service subsystem comprises a dual-stack capable application configured to process DNS queries received as the IPV6 traffic and provide responses based on source-specific IPV6 address policies.

In some embodiments, a system, a process, and/or a computer program product for supporting overlapping IPv4 endpoints in diverse access locations accessing cloud services further includes a log transformer configured to translate IPv6 addresses in application logs back to their corresponding IPv4 addresses for customer-facing logs, ensuring transparency to remote sites unaware of IPV6 remapping.

In some embodiments, a system, a process, and/or a computer program product for supporting overlapping IPv4 endpoints in diverse access locations accessing cloud services further includes a traffic capture module configured to transform captured IPv6 packets in PCAP files to their corresponding IPv4 representations.

These and various other examples for supporting overlapping IPv4 endpoints in diverse access locations accessing cloud services will be further described below with respect to various embodiments.

### Techniques for Supporting Overlapping IPv4 Endpoints in Diverse Access Locations Accessing a Cloud Service

In addition, new and improved techniques for scalable universal description, discovery, and integration (UDDI) for IPV6-based remapping of overlapping IPv4 addresses are disclosed.

In some embodiments, a system, a process, and/or a computer program product for scalable UDDI for IPV6-based remapping of overlapping IPv4 addresses includes receiving Internet Protocol (IP) version 4 (IPv4) traffic at an access termination (e.g., over a secure tunnel); mapping an IPV4 address associated with the IPV4 traffic to an IP version 6 (IPv6) format address using a mapping component of the access termination and rewrite IPv4 packets associated with the IPV4 traffic into IPV6 packets using the IPV6 format address to generate IPV6 traffic, wherein the IPV6 format address encapsulates an access location associated with a source of the IPV4 traffic, wherein the mapping component is configured to assign a unique subnet identifier within a predefined IPV6 address block to each remote site facilitating support for overlapping IPv4 address spaces using the unique subnet identifier for scalable universal description, discovery, and integration (UDDI) for IPV6-based remapping of overlapping IPv4 addresses; and sending the IPV6 traffic to a cloud service (e.g., an application service).

In an example implementation, the mapping component is configured to assign a unique subnet identifier within the predefined IPV6 address block to each remote site facilitating support for up to 65,535 remote sites with overlapping IPv4 address spaces using a 16-bit subnet identifier.

In some embodiments, the application service sends a response using the IPV6 traffic, and further comprises: receiving the IPV6 traffic from the application service at the access termination; mapping the IPV6 format address associated with the IPV6 traffic to an IPV4 format address and rewrite the IPV6 packets associated with the IPV6 traffic into the IPV4 packets using the IPV4 format address to generate the IPv4 traffic; and forwarding the IPV4 traffic to the access location associated with the source of the IPV4 traffic.

In an example implementation, the access termination includes a mapping component for mapping IPV4 addresses to IPV6 addresses that include source access locations associated with sources of the IPV4 traffic.

In an example implementation, the access termination receives a plurality of IPV4 sessions from two or more distinct access locations.

In an example implementation, the access termination includes a mapping component for mapping IPV6 addresses to IPv4 addresses and extracting source access locations associated with sources of the IPV4 traffic for routing the IPV4 traffic to the sources of the IPV4 traffic.

In some embodiments, a system, a process, and/or a computer program product for scalable UDDI for IPV6-based remapping of overlapping IPv4 addresses further includes encapsulating and de-encapsulating the IPV4 traffic from a plurality of remote sites.

For example, by applying the disclosed techniques supporting overlapping IPv4 endpoints in diverse access locations accessing cloud services, network address translation (NAT) tables or per-site network segmentation overlays are not required to handle overlapping IPv4 addresses to support overlapping IPv4 endpoints in diverse access locations accessing cloud services.

In some embodiments, a system, a process, and/or a computer program product for scalable UDDI for IPV6-based remapping of overlapping IPv4 addresses further includes an IPV6-capable application-specific load balancer configured to distribute the IPV6 traffic across multiple service pods for scalability and high availability, wherein the load balancer supports at least one of DNS or DHCP services.

In some embodiments, a system, a process, and/or a computer program product for scalable UDDI for IPV6-based remapping of overlapping IPv4 addresses further includes a service subsystem comprises a dual-stack capable application configured to process DNS queries received as the IPV6 traffic and provide responses based on source-specific IPv6 address policies.

In some embodiments, a system, a process, and/or a computer program product for scalable UDDI for IPV6-based remapping of overlapping IPv4 addresses further includes a log transformer configured to translate IPV6 addresses in application logs back to their corresponding IPv4 addresses for customer-facing logs, ensuring transparency to remote sites unaware of IPV6 remapping.

In some embodiments, a system, a process, and/or a computer program product for scalable UDDI for IPV6-based remapping of overlapping IPv4 addresses further includes a traffic capture module configured to transform captured IPV6 packets in PCAP files to their corresponding IPv4 representations.

These and various other examples for scalable UDDI for IPV6-based remapping of overlapping IPv4 addresses will be further described below with respect to various embodiments.

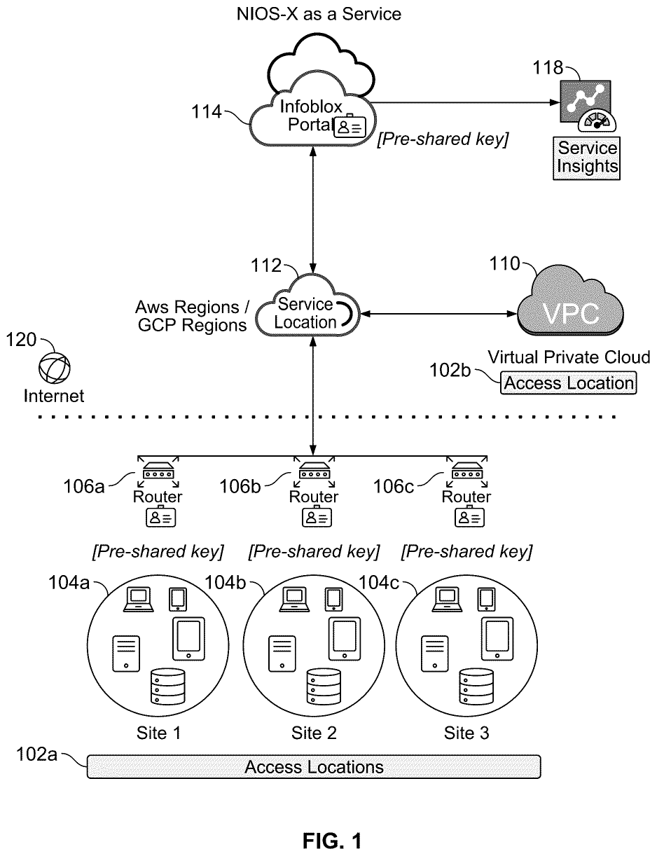

FIG. 1 illustrates an example for providing DDI as a service in the cloud in accordance with some embodiments. For example, NIOS-X as a service (e.g., available via the Internet 120) is commercially available from Infoblox Inc., headquartered in Santa Clara, CA, such as shown in FIG. 1.

In an example implementation, the DDI Service is modelled as a container object, for service capabilities including, for example, DNS, DHCP, and DNS Forward proxy. Access locations 102a can be physical sites hosting a router capable of IPSEC, such as site 1 as shown at 104a, site 2 shown at 104b, and site 3 shown at 104c, which are each in communication with a router as shown at 106a, 106b, and 106c, respectively. As another example, an access location 102b can be a data center or a Virtual Private Cloud (VPC) as shown at 110.

A service location as shown at 112 is where the DDI Service is actually hosted (e.g., using a commercially available cloud computing service, such as Amazon Web Services (AWS), Google Cloud Platform (GCP), and/or another commercially available cloud computing service). For example, AWS US East (N. Virginia) or GCP US West (Oregon) can be provided as service locations in different geographical regions. In this example implementation, the DDI Service (e.g., NIOS-X as a Service) supports many service locations in AWS and GCP (e.g., in Asia, Europe, North America, etc.).

The DDI Services are configured from a portal (e.g., the Infoblox Cloud portal for the NIOS-X as a Service) as shown at 114. The DNS and DHCP services are all running in the service location in the cloud.

As also shown in FIG. 1, the portal 114 is in communication with an analytics service for the DDI Service (e.g., Service Insights for NIOS-X as a Service) as shown at 118. For example, the Service Insights 118 can provide various analytics and insights for enterprise customers of the NIOS-X as a Service regarding their deployed Domain Name System (DNS), Dynamic Host Configuration Protocol (DHCP), and Internet Protocol (IP) Address Management (IPAM) services.

In this example implementation, the NIOS-X as a Service can be configured by establishing site-to-site IPsec VPN tunnels from customer's on-prem devices (e.g., router, firewall, SD-WAN appliance, etc.) to the appropriate NIOS-X as a Service endpoints in the cloud, including, for example, the portal as shown at 114 (e.g., using pre-shared keys as shown in FIG. 1). DNS and/or DHCP traffic can then be routed through the VPN tunnels to Infoblox run cloud services.

However, there exists technical challenges for such a DDI Service with endpoints in diverse access locations (e.g., as shown at 102a and 102b in FIG. 1) as will now be further discussed below.

The diverse access locations, such as Site 1, Site 2, and Site 3 as shown at 104a, 104b, and 104c in FIG. 1, can be hosting several IP endpoints. These diverse access locations can each be consuming similar services, such as DNS and DHCP from the cloud. This technically works well provided that Site 1, Site 2, and Site 3 do not have an IP address space overlap.

Below are four different scenarios that provide examples of what is specifically meant by an example of IP address overlap (e.g., scenario 1—no overlaps, scenario 2—complete overlaps, scenario 3—partial overlaps, and scenario 4—implicit overlaps, as provided in greater detail below).

### Scenario 1: No Overlaps

Site 1 has the address pool 192.168.100.0/24 for its endpoints.
Site 2 has the address pool 192.168.101.0/24 for its endpoints.
Site 3 has the address pool 192.168.102.0/24 for its endpoints.

### Scenario 2: Complete Overlaps

Site 1 has the address pool 192.168.100.0/24 for its endpoints.
Site 2 has the address pool 192.168.100.0/24 for its endpoints.
Site 3 has the address pool 192.168.100.0/24 for its endpoints.

### Scenario 3: Partial Overlaps

Site 1 has the address pool 192.168.100.0/24 for its endpoints.
Site 2 has the address pool 192.168.100.0/24 for its endpoints.
Site 3 has the address pool 192.168.102.0/24 for its endpoints.

### Scenario 4: Implicit Overlaps

Site 1 has the address pool 192.168.100.0/24 for its endpoints.
Site 2 has the address pool 192.168.100.128/25 for its endpoints.

In this scenario, Subnet 2 overlaps with Subnet 1, because the IP range 192.168.1.128 to 192.168.1.255 is included in both subnets.

The impact of such explicit and/or implicit IP address overlaps to the DDI Service provider is that the DDI Service provider is generally then not able to service customer segments where there could be overlapping IP addresses across different sites. As an example, this can be a common scenario in a hotel chain.

When there are such IP address overlaps, several issues can arise including routing conflicts, security risks, service disruption, integration challenges, and/or management complexity, which are each further discussed below.

Routing Conflicts: Overlapping IP addresses can cause ambiguity in the destination address, leading to routing conflicts and network connectivity issues. As such, this can result in DDI service failures.

Security Risks: Overlapping IP addresses pose a security risk due to the facilitation of address spoofing. As an example, attackers can exploit the overlap to impersonate devices and gain unauthorized access to the network.

Service Disruption: Address overlaps can lead to erratic or unreliable traffic patterns, causing significant network disruption.

Integration Challenges: During mergers and acquisitions, or when integrating with cloud providers, overlapping IP addresses can create significant contention challenges.

Management Complexity: Maintaining thorough documentation and visibility into routing policies is crucial to prevent future overlaps. Proactively monitoring and managing IP address allocations using IPAM solutions can generally help mitigate these issues.

Despite the above, the DDI Service provider cannot necessarily influence the customer to change their IP address management in most deployment cases.

As such, new and improved techniques to support overlapping IPv4 endpoints in diverse access locations accessing cloud services are needed, such as similarly discuss above.

Various existing approaches to address this problem can have various shortcomings. Specifically, existing approaches to address IPv4 address overlap include careful IP address planning to avoid conflicts, network-based segmentation using existing technologies (e.g., VXLAN), and Network Address Translation (NAT) mechanisms. Each of these existing approaches and their shortcomings will now be further discussed below.

### Approach 1: IP Address Planning

IP address planning generally involves using unique private IP address blocks across each access location, avoiding common ranges, such as 192.168.1.0/24 or 10.0.0.0/24, which are prone to conflicts. Additionally, care would need to be taken to avoid overlaps during integration with cloud providers.

As similarly discussed above, IP address planning, while effective in controlled environments, is labor intensive, error prone, and, moreover, becomes technically impractical during integration with external networks or in dynamic deployments where site autonomy is preferred.

### Approach 2: Network-Based Segmentation

As similarly discussed above, network segmentation, such as encapsulating traffic with VXLAN identifiers, resolves overlaps by isolating site traffic, but this approach generally requires costly per-site service instances, limiting scalability. For example, a significant drawback of the network-based segmentation approach is the requirement of separate DDI Service instances, to mitigate the overlapping IPs, which is expensive to scale.

### Approach 3: Network Address Translation-Based Mechanisms

As similarly discussed above, NAT-based approaches, which rewrite overlapping IPs to unique addresses, introduce latency, finite table size constraints, and vulnerability to denial-of-service attacks, necessitating complex management strategies, such as rate limiting and load balancing.

Specifically, the use of a NAT table introduces latency, as every packet is subjected to IP packet modification. The NAT table is a finite resource and calls for table management using different strategies.

In addition, NAT tables are subject to Denial of Service (DoS) attacks. For example, attackers can flood the NAT device with a high volume of connection requests, exhausting its resources and causing legitimate connections to be dropped. The number of active connections that a NAT table can manage is limited. Also, deliberate packet fragmentation can be induced, which will lead to high CPU in the NAT module, as packets have to be re-assembled to apply the correct translations.

These drawbacks of NAT can be mitigated and/or worked around as described below.

Rate Limiting: Implement rate limiting to control the number of connections a single IP address can establish within a certain time frame. As such, rate limiting can help prevent any single device from consuming too many NAT resources.

Connection Timeouts: Configure appropriate connection timeout values to ensure that inactive NAT entries are cleared promptly. As such, connection timeouts can help free up resources for new connections.

Access Control Lists (ACLs): Use ACLs to restrict which internal IP addresses or subnets can use NAT. As such, ACLs can help manage and control the flow of traffic through the NAT device.

Load Balancing: Distribute NAT traffic across multiple NAT devices or IP addresses to prevent any single device from becoming a bottleneck. As such, load balancing of NAT traffic across multiple NAT devices can be achieved through round-robin allocation or other load balancing techniques.

Monitoring and Alerts: Implement monitoring tools to track NAT table usage and set up alerts for high usage scenarios. As such, these monitor tools for tracking NAT table usage and alerting allows for proactive management and quick response to potential issues that can arise, such as described above.

Accordingly, new and improved techniques to support overlapping IPv4 endpoints in diverse access locations accessing cloud services are disclosed. Specifically, various embodiments are disclosed that utilize NAT techniques to support overlapping IPv4 endpoints in diverse access locations accessing cloud services as will now be further described below.

### Example System Embodiments for Supporting Overlapping IPv4 Endpoints in Diverse Access Locations Accessing a Cloud Service

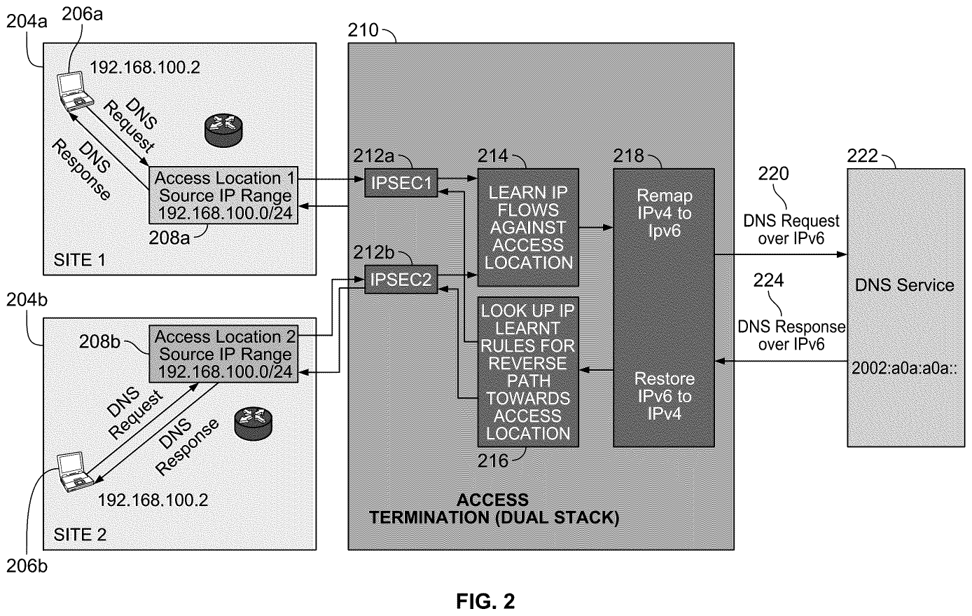

The disclosed new and improved techniques to support overlapping IPv4 endpoints in diverse access locations accessing cloud services will now be further described below with respect to FIG. 2.

FIG. 2 illustrates an example for providing DDI as a service in the cloud to support overlapping IPv4 endpoints in diverse access locations accessing cloud services in accordance with some embodiments. Specifically, in this example solution to support overlapping IPv4 endpoints in diverse access locations accessing cloud services, IPv4 traffic flows are remapped to IPV6 flows as will be further described below with respect to FIG. 2.

Referring to FIG. 2, the diverse access locations, including site 1 as shown at 204a and site 2 as shown at 204b, need not be aware of Internet Protocol version 6 (IPv6) (e.g., IPv6 addresses). As shown in these example distinct access locations at 208a and 208b, respectively, site 1 and site 2 share an overlapping IP source address range of 192.168.100.0/24.

In this example, an endpoint 206a is in communication with an access termination (dual stack) 210, and similarly another endpoint 206b is also in communication with the Access Termination (dual stack) 210 that performs processing of any DNS requests, such as shown at 220 sent from these endpoints to a DNS service 222, as will now be further described below.

As shown, an endpoint 206a or 206b initiates a DNS Request that is received at an Access Location 1 as shown at 208a or at an Access Location 2 as shown at 208b, respectively. In this example implementation, the DNS Request is intercepted using the Access Termination (dual stack) 210 at an IPSEC1 tunnel termination 212a or at an IPSEC2 tunnel termination 212b.

The DNS requests are then forwarded to another component for performing an operation for learning IP flows against access locations as shown at 214 of the Access Termination (dual stack) 210. Specifically, this component is configured to learn the IP flows against which the IPSEC interface was the source of each respective DNS request, such as IPSEC1 tunnel termination 212a or IPSEC2 tunnel termination 212b.

The DNS requests are then forwarded to another component (e.g., a mapping component) for performing an operation for remapping an IPV4 address to an IPV6 address (e.g., an IPV4 to IPV6 and IPV6 to IPv4 translator component) as shown at 218 of the Access Termination (dual stack) 210. An example implementation of a process for performing the operation for remapping an IPV4 address to an IPV6 address will be further described below.

The result of this operation is to translate the DNS Request over IPv4 to a new format of the DNS request over IPv6 as shown at 220, which is received at the DNS Service 222.

The DNS Service 222 processes the DNS Request over IPv6 220 and returns a DNS Response over IPv6 as shown at 224.

The DNS Response over IPv6 224 is received at the Access Termination (dual stack) 210. Specifically, the IPV4 to IPV6 and IPV6 to IPv4 translator component performs an operation remapping an IPV6 address associated with the DNS Response over IPv6 224 to restore the original IPv4 address associated with the original, source DNS request to generate the DNS Response over IPv4.

The DNS Response over IPv4 is then sent to another component for performing an operation for looking up the IP learned rules for reverse path towards the access location as shown at 216 of the Access Termination (dual stack) 210. Specifically, this component is configured to utilize the previously learned rules (e.g., the rules that were learned as described above for learning IP flows against access locations using component 214 as described above) to determine whether the original IP flow associated with the DNS Request and DNS Response is associated with which IPSEC interface (e.g., the IPSEC interface that was the source of each respective DNS request, such as IPSEC1 tunnel termination 212a or IPSEC2 tunnel termination 212b, such as similarly described above).

Based on the determination of which IPSEC interface was the source of the associated DNS Request corresponding to the DNS Response, the DNS Response over IPV4 is then routed over the original source IPSEC interface (e.g., IPSEC1 tunnel termination 212a or IPSEC2 tunnel termination 212b, such as similarly described above). The DNS Response over IPv4 is then sent to the corresponding Access Location (e.g., Access Location 1 as shown at 208a or Access Location 2 as shown at 208b) that is then sent to the original endpoint (e.g., endpoint 206a or endpoint 206b, respectively).

As discussed above with respect to FIG. 2, IPV6 services can be used to provide application services in lieu of IPV4 services (e.g., using the Access Termination (dual stack) as shown at 210 of FIG. 2) as will now be further described below.

Mapping of destination IPv4 address to the v6 Service IP

In an example implementation, IPv4 addresses are mapped to IPV6 addresses as specified in RFC 3056-Connection of IPV6 Domains via IPv4 Clouds (e.g., which is publicly available at https://datatracker.ietf.org/doc/html/rfc3056).

Specifically, IPv6 addresses mapped to IPv4 addresses (e.g., also referred to herein as 6to4) are an IPV6 transition mechanism that allows IPV6 packets to be transmitted over an IPV4 network without the need for explicit tunnels.

More specifically, the IPV6 transition mechanism embeds the IPV4 address within the IPV6 address, thereby enabling communication between IPV4 and IPV6 networks.

As an example, assume that we have the following example IPv4 address: 10.10.10.10.

The operations to map this example IPV4 address to an IPV6 6to4 address are provided below.

First, a Prefix Addition operation is performed. Specifically, the 6to4 prefix is 2002::/16. This prefix is used to indicate that the address is a 6to4 address.

Second, an Embedding of the IPV4 address operation is performed to convert the IPv4 address to hexadecimal. For the example IPv4 address of 10.10.10.10, the hexadecimal conversion of 10.10.10.10 is 0A0A: 0A0A.

Third, a Constructing of the IPV6 address operation is performed to combine the 6to4 prefix with the hexadecimal representation of the IPV4 address.

As such, in this example, the resulting IPV6 address is 2002:0A0A: 0A0A::/48.

Mapping overlapping source IPv4 address to the IPV6 unique source IP

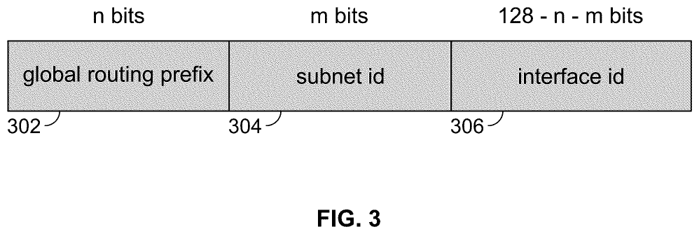

FIG. 3 illustrates the current format of the IPV6 address. Specifically, the current format of the IPV6 address is defined in https://www.rfc-editor.org/rfc/rfc3587.html.

Referring to FIG. 3, n bits are used for the global routing prefix as shown at 302, a subnet id that is m-bits as shown at 304, and the remainder of the 128 bits is assigned for the interface id (e.g., 128 bits-n bits-m bits) as shown at 306.

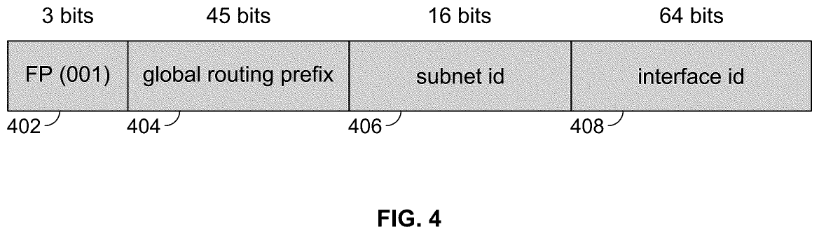

FIG. 4 illustrates a more flexible format of the IPV6 address in accordance with some embodiments.

Referring to FIG. 4, 3 bits are used for the Format Prefix (FP) as shown at 402, 45 bits are used for the global routing prefix as shown at 404, a subnet id that is 16 bits is shown at 406, and the remainder of the 128 bits is assigned for the interface id (e.g., 64 bits) as shown at 408.

Specifically, the definition is now more flexible, and it is not a mandate, but more of a recommendation to use the subnet-id and interface-id concepts.

More specifically, the American Registry for Internet Numbers (ARIN) assigns/48 prefixes as a minimum block. If we desire, for example, a lower sized block which is likely to be more than sufficient, then we could get it from the ISPs.

This could be one possible address block allocation, for the 2001:400::/23 allocated to ARIN, such as provided below.
1. 2001:400:0000::/48
2. 2001:400:0100::/48
3. 2001:400:0200::/48
4. 2001:400:0300::/48
5. 2001:400:0400::/48
6. 2001:400:0500::/48
7. 2001:400:0600::/48
8. 2001:400:0700::/48
9. 2001:400:0800::/48
10. 2001:400:0900::/48

Let us take 2001:400:0900::/48 as the seed block. We can use the subnet ID subsection of the address to represent up to 216 or 65535 access locations or IPV4 sites, with overlapping IPv4 addresses.

Again, there is no mandate to use 16 bits alone. As an example, we could also have a scheme where we use 32 more bits of the interface id (e.g., leaving the rest of the 32 bits for the space to support the IPV4 address) to support a total of up to 248 or 281,474,976,710,656 (e.g., a number in trillions) access locations or IPv4 sites, with overlapping IPv4 addresses.

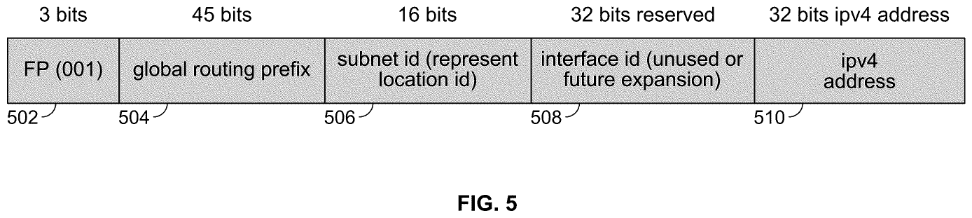

FIG. 5 illustrates a format of the IPV6 address to facilitate identification of access locations in accordance with some embodiments.

In an example implementation, 16 bits of the subnet ID can be used to uniquely identify the access locations (e.g., such as shown at 204a and 204b in FIG. 2). This example encompasses the potential use of 32 additional bits of interface id, however, for this purpose.

Referring to FIG. 5, 3 bits are used for the Format Prefix (FP) as shown at 502, 45 bits are used for the global routing prefix as shown at 504, a subnet id that is 16 bits is shown at 506 (e.g., to be used to represent the location id, such as the access location), an interface id that is 32 bits (e.g., unused or for future expansion) is shown at 508, and the final 32 bits are used for embedding the IPv4 address as shown at 510.

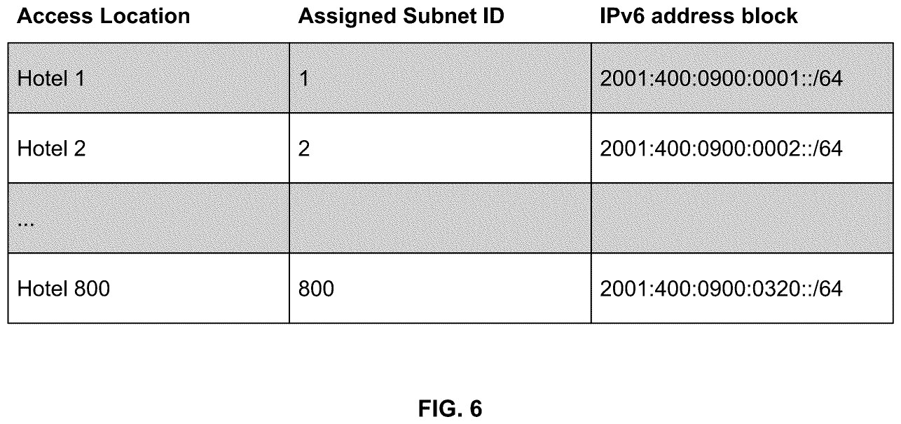

FIG. 6 illustrates an example addressing table in accordance with some embodiments.

Referring to FIG. 6, assuming 2001:400:0900::/48 as the seed address, the access locations can be assigned IPv4 addresses as shown in the table of FIG. 6.

Representation of the overlapping IPv4 addresses

In this example implementation, the guidelines specified in IETF RFC 6052 (e.g., which is publicly available at https://datatracker.ietf.org/doc/html/rfc6052 #section-2.2) related to embedding IPv4 address in IPV6 are followed.

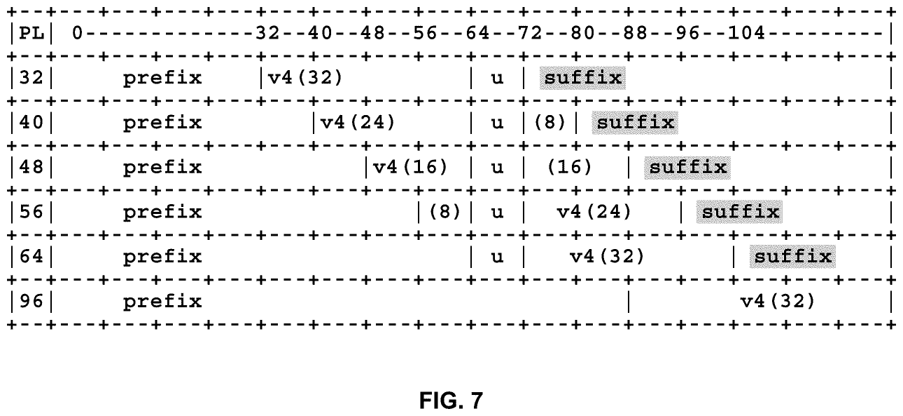

FIG. 7 illustrates example formats depending on the size of an IPV6 prefix in accordance with some embodiments.

As shown in FIG. 7, there are several formats possible, some like below depending on the size of the IPV6 prefix.

In an example implementation, given that the suffix is null, the/96 format can be used as shown in FIG. 7.

As such, using the/96 format, the entire least significant 32 bits can be utilized for the IPV4 address in this example implementation.

As will now be apparent to one of ordinary skill in the art in view of the disclosed embodiments, various other formats shown in FIG. 7 can similarly be used for performing the disclosed techniques to support overlapping IPv4 endpoints in diverse access locations accessing cloud services.

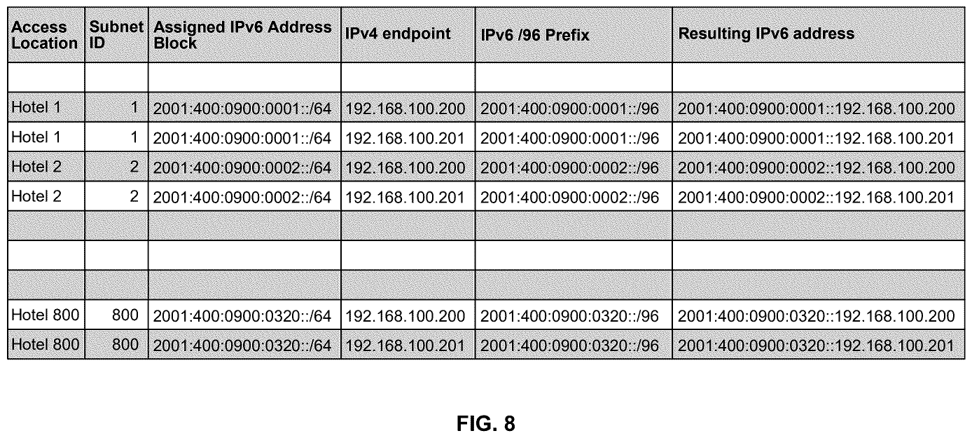

FIG. 8 illustrates an example for overlapping IPv4 addresses across several locations in accordance with some embodiments.

Specifically, the mapping of IPV4 addresses can be provided as shown in the example table for overlapping IPv4 addresses across several locations as shown in FIG. 8.

In this example, overlapping IPv4 address 192.168.100.200 in locations Hotel 1, Hotel 2, and Hotel 800 are remapped to 2001:400:0900:0001::192.168.100.200/128, 2001:400:0900:0002::192.168.100.200/128, and 2001:400:0900:0320::192.168.100.200/128, respectively.

These now unique packet flows with IPV6 addresses can be subjected to their own specific application treatments and policies, such as similarly described above with respect to FIG. 2.

### Other 6to4 Mapping Techniques

There are other potential mapping mechanisms.

As an example, a 6-4 tunnel can be used, such as described in https://datatracker.ietf.org/doc/html/rfc3056.

As another example, Unique Local IPV6 addresses can be used, such as described in https://datatracker.ietf.org/doc/html/rfc4193.

The advantage that these alternative 6to4 mapping techniques offer is in terms of paying zero cost to ARIN.

However, there may be other reasons that an implementer may not elect to utilize one or more of these alternative 6to4 mapping techniques. For example, they are not as elegant to implement in the data plane or the packet path (e.g., the mapped IPv4 address would generally have to be distributed across spread apart sub-fields in the defined IPV6 formats in these RFCs).

In some embodiments, one of the above-described 6to4 mapping techniques is implemented using the Access Termination (dual stack) 210 (e.g., and sub-component 218) as shown in FIG. 2 for performing the disclosed techniques to support overlapping IPv4 endpoints in diverse access locations accessing cloud services.

Alternatively, another 6to4 mapping technique can similarly be implemented using the Access Termination (dual stack) 210 (e.g., and sub-component 218) as shown in FIG. 2 for performing the disclosed techniques to support overlapping IPv4 endpoints in diverse access locations accessing cloud services.

### Datapath Considerations

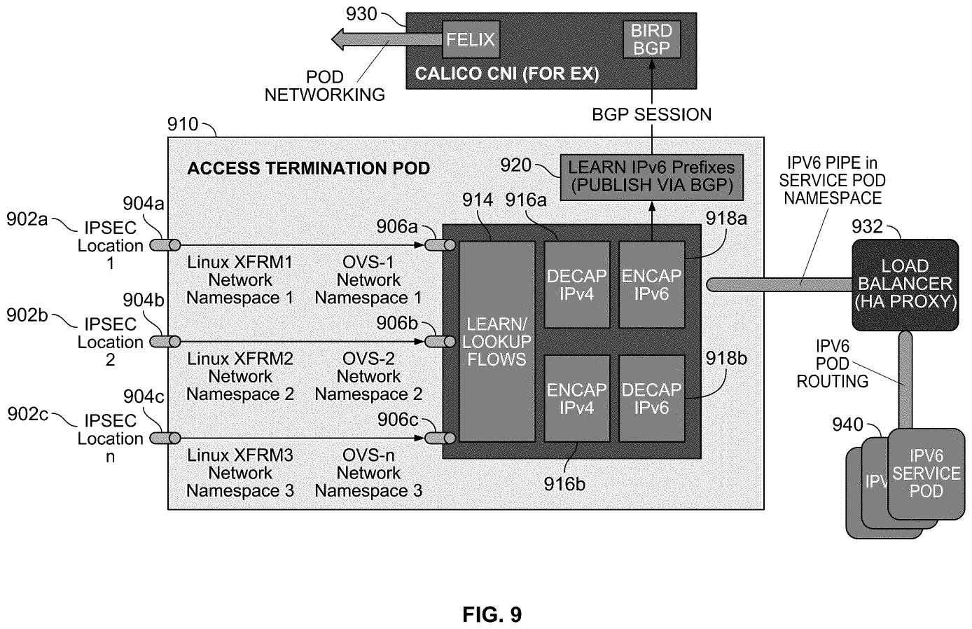

FIG. 9 illustrates an example dataflow diagram to support overlapping IPv4 endpoints in diverse access locations accessing cloud services in accordance with some embodiments.

Specifically, FIG. 9 illustrates an example implementation of the disclosed techniques to support overlapping IPv4 endpoints in diverse access locations accessing cloud services in a Kubernetes container computing environment. As will be apparent to one of ordinary skill in the art, the disclosed techniques to support overlapping IPv4 endpoints in diverse access locations accessing cloud services can similarly be implemented in other computing environments, such as virtual machine (VM) or other container-based environments, etc.

Referring to FIG. 9, multiple IPSEC locations, represented as Location 1 at 902a, Location 2 at 902b, Location n at 902c, and so on, serve as the source of traffic. These are processed on an Access Termination Pod as shown at 910. In this example implementation, the network traffic from these locations is decrypted or encrypted using Linux XFRM (e.g., IPSEC framework) operating in their respective network namespaces as shown at 904a, 904b, and 904c. As shown at 906a, 906b, and 906c, the virtual switch used is OVS as an example, or any other virtual switch can similarly be used.

The decrypted IPSEC ipv4 traffic egresses off their respective XFRM network interfaces. As an example these network interfaces are connected to their OVS network interfaces as shown at 906a, 906b, and 906c. The network interface pair comprising XFRM and OVS interface, for each location, needs to be placed in a unique network namespace, considering the overlapping IPv4 address spaces.

Learning and looking up IP flows component 914 can be implemented as similarly described above with respect to FIG. 2 (e.g., describing components 214 and 216).

Specifically, the destination IPv4 address for each flow is popped and transformed into the IPV6 address using DECAP IPv4 component 916a and ENCAP IPV6 component 918a as described above regarding an example implementation of mapping of destination IPv4 addresses to the V6 service IP.

The source IPV4 address for the flows is popped and remapped to an IPV6 address using DECAP IPV6 component 918b and ENCAP IPV4 component 916b as described above regarding an example implementation of mapping overlapping source IPv4 addresses to the V6 unique source IP.

The disclosed techniques also do not require an explicit network overlay like VXLAN for intra pod traffic steering. Instead, the BGP capabilities of the Kubernetes Container Network Interface (CNI) (e.g., in this example implementation, Calico is used for route learning) are shown at 930. There are other CNIs that can similarly be used, such as Cillium, which support this as well.

As shown at 920-, the transformed source IPV6 and the prefixes are injected into the Border Gateway Protocol (BGP). Specifically, a BGP session is established with the CNI in advance. This enables the return IPV6 traffic from the service pod to be steered to the access termination pod.

As also shown in FIG. 9, to horizontally scale the service pods and high availability, an IPV6 Application specific load balancer (e.g., for high availability) is used in this example implementation as shown at 932. Examples of commercially available load balancer implementations that can be used include NGINX or HAProxy for DNS traffic (e.g., or other commercially available load balancers can similarly be used). For DHCP services, an example commercially available load balancer that can be used is Meta's DHCPLB (e.g., or other commercially available load balancers can similarly be used).

As shown at 940 of FIG. 9, IPv6-enabled service pods handle application-level processing, with traffic routing within the cluster relying on IPV6 pod routing mechanisms provided by the CNI.

Processed IPV6 responses from the service pods are routed back to the Access termination Pod 910. A reverse lookup operation is performed (e.g., using Learn/Lookup Flows component 914), remapping IPv6 source and destination addresses to IPV4. Traffic is redirected back into the corresponding network namespace and is IPSEC encapsulated using XFRM.

As such, the above described techniques facilitate use of EBPF while avoiding a NAT lookup.

### Considerations for Server-side Applications

Considerations for server-side applications is explained using one scenario below, and as would be apparent to one of ordinary skill in the art, there are various other scenarios.

Consider the example of Bind for DNS processing.

The application service should be dual stack capable. For example, BIND 9 can listen for DNS queries on both IPV4 and IPV6 interfaces. By default, BIND 9.10 and later versions listen on all available IPv4 and IPV6 interfaces. Some configuration snippets are presented for clarity.

```
options {
  listen-on { any; };
  listen-on-v6 { any; };
};
```

Other considerations may include using IPv4 for recursive DNS queries, despite getting the original DNS requests as IPv6.

```
options {
  // Other options...
  query-source address * port 53;
  // query-source-v6 address :: port 53; Don't query using Ipv6
};
```

Bind can be configured to provide different responses, depending on the source of the DNS querier. This generally has to be managed, and the configurations related to DNS views should instead have the transformed IPV6 address.

Below is an example config snippet.

```
acl “internal” {
  //192.168.100.0/24; // This is commented, as it has to be mapped to
  IPv6 as 2001:400:0900:0001::192.168.100.0/120;
};
acl “external” {
  any;
};
view “internal” {
  match-clients { “internal”; };
  zone “example.com” {
    type master;
    file “internal/example.com.db”;
  };
  zone “1.168.192.in-addr.arpa” {
    type master;
    file “internal/192.168.1.db”;
  };
};
view “external” {
  match-clients { “external”; };
  zone “example.com” {
    type master;
    file “external/example.com.db”;
  };
  zone “1.168.192.in-addr.arpa” {
    type master;
    file “external/192.168.1.db”;
  };
};
Considerations for Kubernetes
```

In the above-described example Kubernetes implementation (e.g., as shown in FIG. 9), a Kubernetes CNI that is dual stack capable is utilized (e.g., CNIs, such as Flannel, would not be sufficient). As similarly described above, commercially available CNIs, such as Cillium or Calico, are dual stack capable, and also provide support for BGP.

### Considerations for Logging

Generally, Customers need not be aware of the internal implementation of using IPv6 to support overlapping IPv4 endpoints in diverse access locations accessing cloud services.

Application logs may have IPV6 addresses marked, and this could be confusing for the customer. As such, in some embodiments, a log transformer function can also be provided, which will translate the IPV6 addresses in the logs to their respective IPV4 addresses (e.g., even if IPv4 NAT was used, such a log transformer function would be similarly desirable to solve this problem).

### Considerations for Traffic Capture

In some embodiments, for features like traffic capture, we can transform the IPV6 packets in PCAPs to IPv4. For example, publicly available tools, such as the tcprewrite tool, can be used that have an option to convert IPV6 to IPV4.

### Example Process Embodiments for Supporting Overlapping IPv4 Endpoints in Diverse Access Locations Accessing a Cloud Service

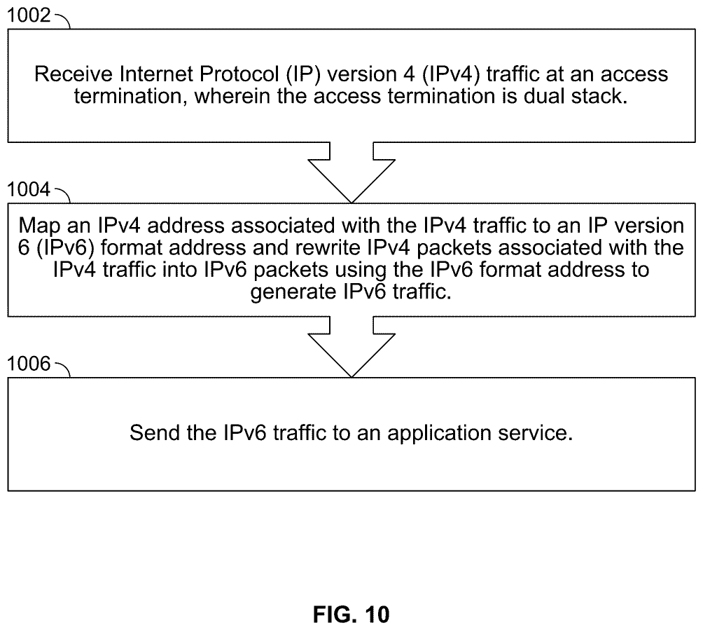

FIG. 10 illustrates a flow diagram of a process to support overlapping IPv4 endpoints in diverse access locations accessing cloud services in accordance with some embodiments. In some embodiments, the process can be performed using the embodiments as similarly described above, such as with respect to FIGS. 2 and/or 9.

At 1002, Internet Protocol (IP) version 4 (IPv4) traffic is received at an access termination, wherein the access termination is dual stack.

At 1004, mapping an IPV4 address associated with the IPv4 traffic to an IP version 6 (IPv6) format address and rewriting IPv4 packets associated with the IPV4 traffic into IPV6 packets using the IPV6 format address to generate IPV6 traffic is performed. For example, the IPV6 format address encapsulates an access location associated with a source of the IPV4 traffic, such as similarly described above.

In some embodiments, a mapping component is configured to assign a unique subnet identifier within a predefined IPV6 address block to each remote site facilitating support for overlapping IPv4 address spaces using the unique subnet identifier for scalable universal description, discovery, and integration (UDDI) for IPV6-based remapping of overlapping IPv4 addresses, such as similarly described above (e.g., with respect to FIG. 2).

At 1006, sending the IPV6 traffic to an application service is performed. For example, the application service can include a DNS service, a DHCP service, or a Network Time Protocol (NTP) service, or any other application service (e.g., which can include a network service or other cloud services), such as similarly described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive Internet Protocol (IP) version 4 (IPv4) traffic at an access termination, wherein the access termination is dual stack;
map an IPV4 address associated with the IPV4 traffic to an IP version 6 (IPv6) format address and rewrite IPv4 packets associated with the IPV4 traffic into IPv6 packets using the IPV6 format address to generate IPV6 traffic, wherein the IPV6 format address encapsulates an access location associated with a source of the IPV4 traffic; and
send the IPV6 traffic to an application service; and
a memory coupled to the processor and configured to provide the processor with instructions.

2. The system of claim 1, wherein the application service includes a DNS service, a DHCP service, or a Network Time Protocol (NTP) service.

3. The system of claim 1, wherein the application service sends a response using the IPV6 traffic, and wherein the processor is further configured to:
receive the IPV6 traffic from the application service at the access termination; and
map the IPV6 format address associated with the IPV6 traffic to an IPV4 format address and rewrite the IPv6 packets associated with the IPV6 traffic into the IPV4 packets using the IPV4 format address to generate the IPV4 traffic.

4. The system of claim 1, wherein the application service sends a response using the IPV6 traffic, and wherein the processor is further configured to:
receive the IPV6 traffic from the application service at the access termination;
map the IPV6 format address associated with the IPV6 traffic to an IPV4 format address and rewrite the IPv6 packets associated with the IPV6 traffic into the IPV4 packets using the IPV4 format address to generate the IPV4 traffic; and
forward the IPV4 traffic to the access location associated with the source of the IPV4 traffic.

5. The system of claim 1, wherein the access termination includes a mapping component for mapping the IPv4 address to the IPV6 format address that includes embedding a distinct site identifier for the access location associated with the source of the IPV4 traffic in the IPV6 format address.

6. The system of claim 1, wherein the access termination includes a mapping component for mapping IPv4 addresses to IPv6 addresses that include source access locations associated with sources of the IPv4 traffic.

7. The system of claim 1, wherein the access termination includes a mapping component for mapping IPv6 addresses to IPv4 addresses and extracting source access locations associated with sources of the IPV4 traffic for routing the IPV4 traffic to the sources of the IPV4 traffic.

8. The system of claim 1, wherein the access termination receives a plurality of IPV4 sessions from two or more distinct access locations.

9. The system of claim 1, wherein the IPV4 traffic is received at the access termination over a secure tunnel.

10. The system of claim 1, wherein the processor is further configured to encapsulate and de-encapsulate the IPv4 traffic from a plurality of remote sites.

11. The system of claim 1, wherein network address translation (NAT) tables or per-site network segmentation overlays are not required to handle overlapping IPv4 addresses to support overlapping IPv4 endpoints in diverse access locations accessing cloud services.

12. The system of claim 1, further comprising an IPV6-capable application-specific load balancer configured to distribute the IPv6 traffic across multiple service pods for scalability and high availability, wherein the load balancer supports at least one of DNS or DHCP services.

13. The system of claim 1, wherein a service subsystem comprises a dual-stack capable application configured to process DNS queries received as the IPV6 traffic and provide responses based on source-specific IPv6 address policies.

14. The system of claim 1, further comprising a log transformer configured to translate IPV6 addresses in application logs back to their corresponding IPv4 addresses for customer-facing logs, ensuring transparency to remote sites unaware of IPV6 remapping.

15. The system of claim 1, further comprising a traffic capture module configured to transform captured IPv6 packets in PCAP files to their corresponding IPv4 representations.

16. A method, comprising:
receiving Internet Protocol (IP) version 4 (IPv4) traffic at an access termination, wherein the access termination is dual stack;
mapping an IPv4 address associated with the IPV4 traffic to an IP version 6 (IPv6) format address and rewrite IPv4 packets associated with the IPV4 traffic into IPv6 packets using the IPV6 format address to generate IPv6 traffic, wherein the IPV6 format address encapsulates an access location associated with a source of the IPV4 traffic; and
sending the IPv6 traffic to an application service.

17. The method of claim 16, wherein the application service includes a DNS service, a DHCP service, or a Network Time Protocol (NTP) service.

18. The method of claim 16, wherein the application service sends a response using the IPV6 traffic, and further comprising:
receiving the IPV6 traffic from the application service at the access termination; and
mapping the IPV6 format address associated with the IPV6 traffic to an IPV4 format address and rewrite the IPV6 packets associated with the IPV6 traffic into the IPV4 packets using the IPV4 format address to generate the IPV4 traffic.

19. A computer program product embodied in a non-transitory computer readable medium and comprising computer instructions for:
receiving Internet Protocol (IP) version 4 (IPv4) traffic at an access termination, wherein the access termination is dual stack;
mapping an IPV4 address associated with the IPV4 traffic to an IP version 6 (IPv6) format address and rewrite IPv4 packets associated with the IPV4 traffic into IPV6 packets using the IPV6 format address to generate IPv6 traffic, wherein the IPV6 format address encapsulates an access location associated with a source of the IPV4 traffic; and
sending the IPv6 traffic to an application service.

20. The computer program product of claim 19, wherein the application service includes a DNS service, a DHCP service, or a Network Time Protocol (NTP) service.
